(19) United States
(12) Patent Application Publication
(10) Pub. No.: US 2017/0046789 A1
(43) Pub. Date: Feb. 16, 2017

(54) System and method for citizen reporter app and web platform

(71) Applicant: Jerry Scott Godwin, Rockville, MD (US)

(72) Inventor: Jerry Scott Godwin, Rockville, MD (US)

(21) Appl. No.: 14/756,189

(22) Filed: Aug. 14, 2015

(51) Int. Cl. G06Q 40/00; G06Q 50/00

(52) U.S. Cl. CPC G06Q 40/12; G06Q 50/01

(57) ABSTRACT

In one example, we describe a system and method for citizen reporter app and web platform. The features help popularize the news gathering by regular people, as crowd sourcing, for free or almost free, which makes the news less biased and more immediate, from many points of views, and from many sources, which gives more credibility with the news, with tools or methods of verifications or confirmations by other members of public nearby and/or about the same time. The vast access to people around the world as amateur reporters (systematically and continuously) has never been done before. We will show examples and variations of the system and method.

### BACKGROUND OF THE INVENTION

Reporting news through Internet is a very popular method of distribution of news, based on a large number of people accessing Internet from all over the world. Reporting news with video is a new phenomenon, enabled with wide access to cameras or video recorders, as well as voice, with good resolution, by many people around the world, mostly using smart phones, with less expensive but very powerful cameras and lenses.

We are using this as our platform for the mobile app and the web access, for regular people in the street all over the world, to gather news and interesting events, record them, and distribute or share them with friends or public or others around the world, on a very timely basis, almost instantaneously and in real-time, as it happens. Because any person can become a reporter, for a very valuable or unexpected or surprising event, we will potentially have over 7 billion reporters, increasing the chances of capturing a very interesting event at the right time and location.

The invention and embodiments described here, below, have not been addressed or presented in any prior art.

### SUMMARY OF THE INVENTION

In one embodiment, we describe a system and method for citizen reporter app and web platform. The features help popularize the news gathering by regular people, as crowd sourcing, for free or almost free, which makes the news less biased and more immediate, from many points of views, and from many sources, which gives more credibility with the news, with tools or methods of verifications or confirmations by other members of public nearby and/or about the same time. The vast access to people around the world as amateur reporters (systematically and continuously) has never been done before.

It is a very wide access to various topics, or locations, or events, where a regular reporter may not get to on time (or access it at all), recording the history and events, and also making it available 24×7×365, all year around, for all to see and access. This can be free or on subscription or based on project or limited scope payment, to pay for the infrastructure and IT equipment or cloud, and make money for the website directly or through user base, e.g., with ads (regular or mobile ads).

### BRIEF DESCRIPTION OF THE DRAWINGS

FIG. 1 is for one embodiment, as an example, for our system, as how to set up the website and platform for our video news service.

FIG. 2 is for one embodiment, as an example, for our system, for some of the components of our platform.

### DETAILED DESCRIPTION OF THE PREFERRED EMBODIMENTS

Our platform for the citizen reporter app (and its web platform) is called Vox Report. Basically, the platform allows a short video to be uploaded, and then from there, it can be shared on social media, via email and text message, with links or addresses. The platform encourages users to record a person-on-the-street eyewitness news/events/perspectives video of about 1-2 minutes, e.g., using the suggested reporting format of the 5Ws (Who, When, Where, What and Why). The citizen reporter news reports are unfiltered, unedited, and direct-published, and Vox Report is unaffiliated with any news organization. Basically, it is crowdsourcing of news (true social media). The URL address is: www.voxreport.com, with these links to the app stores:

iOS Apple:

https://itunes.apple.com/us/app/vox-report/id878462398?mt=8

Google Play Android:

https://play.google.com/store/apps/details?id=com.shareitmobile.android.vox

We have been getting a lot of traction in Ukraine and Venezuela recently, and many of the videos are very remarkable. The key differentiating factor is that the other companies publish material via print or website—push print material to consumers, whereas Vox Report has multimedia user-generated material. So, it is more of a pull situation. Our app and web platform is more indicative of today's social media trends and technology, and it is very different from the more traditional print media models that have been around for hundreds of years.

Our method and system include:

1) Establish an automated news feed service based on submitted user generated news/eyewitness videos stories.

2) Establish a revenue sharing algorithm/process with users who provide user generated video news reports on our platform. The revenues would come from views/advertising from the online community.

3) An Assignments feature that would assign or task registered users to cover a story/event/breaking piece by identifying their proximity to the event. Then, paying them for the videos purchased by other media outlets.

4) A “meter” below each video that would measure and show how many hits/views per second, over a predetermined amount of time, say, e.g., three days, rather than just number over the length of the time that the news video has been posted.

5) An internal search algorithm for videos uploads for the site.

6) A flagging feature that if a certain percentage (perhaps, e.g., 60%) of unique viewers flag a video for being inappropriate, then it comes down automatically, or gets reviewed by our management team, manually.

An example:

A method of splitting ad revenue with a reporter or an owner of a video content, said method comprising: receiving a request to register from a reporter with a central computer; issuing a unique identification code for said reporter for registration confirmation; said reporter capturing a video from an event; said reporter sending said video to a repository; said central computer controlling said repository; a third party viewing said video from said repository; said third party setting a monetary value on said video; said reporter receiving said monetary value through an email or text message from said central computer; if said reporter approves said monetary value, then said central computer notifying said third party to pay said monetary value; said third party paying said monetary value to an account of said central computer; and said central computer transferring a percentage of said monetary value to an account belonging to said reporter.

Other examples: The method of splitting ad revenue with a reporter or an owner of a video content:

wherein said percentage is predetermined.

wherein said percentage is based on a table.

wherein said percentage is based on a curve.

wherein said percentage was negotiated before.

wherein said percentage is based on a contract.

wherein said percentage is based on a performance.

wherein said percentage is based on a number of views.

wherein said percentage is based on a website traffic.

wherein said percentage is adjusted dynamically.

wherein said percentage is adjusted conditionally.

wherein said unique identification code is based on public-private key infrastructure.

wherein said unique identification code is based on an encryption method.

wherein said method comprises: rating said video.

reporting said video as offensive.

evaluating said video as being offensive.

deleting said video as offensive.

generating total accounting report for said reporter.

crowdsourcing said event to public, for video capturing.

metering said video for accounting purposes and rating purposes.

In the social media for crowdsourcing of news, as it relates to user generated content (specifically videos), we have a revenue sharing platform that splits revenues with users contributing to the specific news. Users would contribute to the specific news and would get a revenue split with us, e.g., from advertising or sponsorship for a specific subject. This encourages more contributions in terms of quality and quantity for the news.

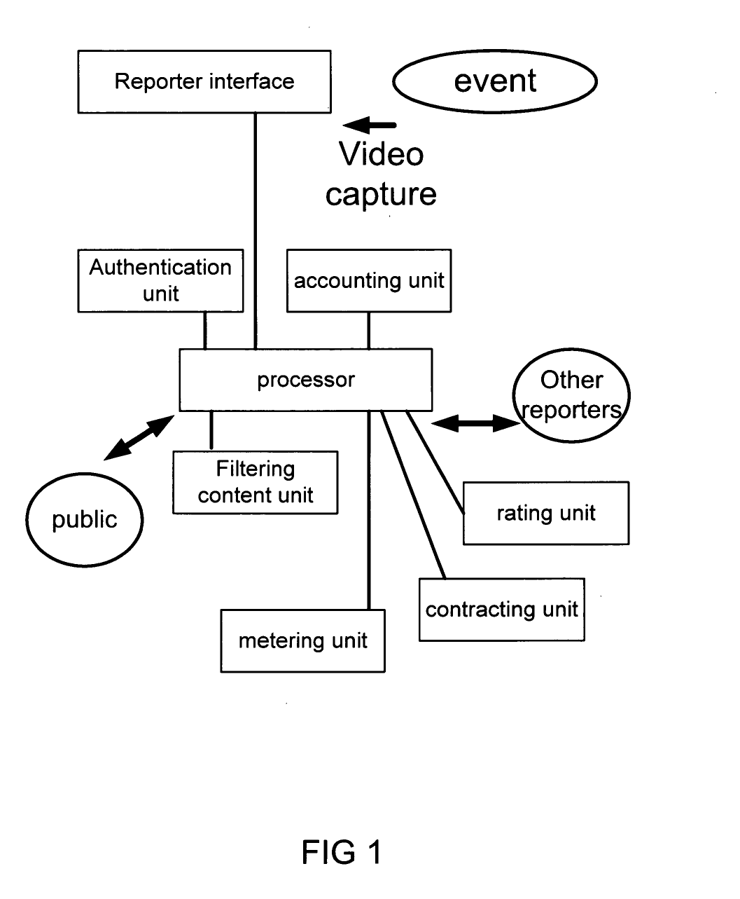

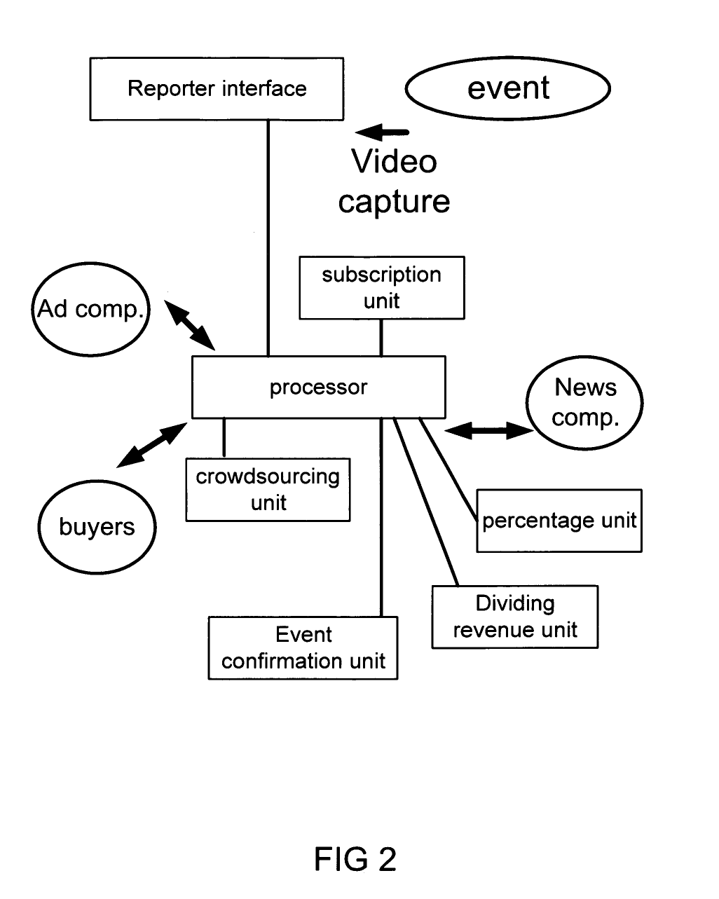

FIG. 1 is for one embodiment, as an example, for our system, as how to set up the website and platform for our video news service. FIG. 2 is for one embodiment, as an example, for our system, for some of the components of our platform.

In another embodiment, we have a simplified advertising platform using video advertisements produced by users with video ads recorded on their smart phones or cameras, and then incorporating the ads into social media platforms to gain viewers and expand promotional campaigns. Any user or business owner can record their own promotional videos with a smart phone or camera and upload to social media to promote their businesses, services, products, or causes. The ad length would range from e.g., 15 sec, 30 sec, 45 sec, and so on, but no longer than 1 minute.

The ads would go through a short review process to determine suitability before publishing. The ads would play or show based on demographic choice algorithms and pre-set budgets. Advertisers would be encouraged to “produce” good quality ad videos to get more views, which is a win-win situation for all. The intent is to make advertising more accessible to online and mobile platform users.

The systems above can be implemented with servers or server farms or central computers or processors. The mobile devices can be smart phones, pads, tablets, laptops, watches, or any device attached to the body.

Any variations of the above teaching are also intended to be covered by this patent application.

1. A method of splitting ad revenue with a reporter or an owner of a video content, said method comprising:
receiving a request to register from a reporter with a central computer;
issuing a unique identification code for said reporter for registration confirmation;
said reporter capturing a video from an event;
said reporter sending said video to a repository;
said central computer controlling said repository;
a third party viewing said video from said repository;
said third party setting a monetary value on said video;
said reporter receiving said monetary value through an email or text message from said central computer;
if said reporter approves said monetary value, then said central computer notifying said third party to pay said monetary value;
said third party paying said monetary value to an account of said central computer; and
said central computer transferring a percentage of said monetary value to an account belonging to said reporter.

2. The method of splitting ad revenue with a reporter or an owner of a video content, as recited in claim 1, wherein said percentage is predetermined.

3. The method of splitting ad revenue with a reporter or an owner of a video content, as recited in claim 1, wherein said percentage is based on a table.

4. The method of splitting ad revenue with a reporter or an owner of a video content, as recited in claim 1, wherein said percentage is based on a curve.

5. The method of splitting ad revenue with a reporter or an owner of a video content, as recited in claim 1, wherein said percentage was negotiated before.

6. The method of splitting ad revenue with a reporter or an owner of a video content, as recited in claim 1, wherein said percentage is based on a contract.

7. The method of splitting ad revenue with a reporter or an owner of a video content, as recited in claim 1, wherein said percentage is based on a performance.

8. The method of splitting ad revenue with a reporter or an owner of a video content, as recited in claim 1, wherein said percentage is based on a number of views.

9. The method of splitting ad revenue with a reporter or an owner of a video content, as recited in claim 1, wherein said percentage is based on a website traffic.

10. The method of splitting ad revenue with a reporter or an owner of a video content, as recited in claim 1, wherein said percentage is adjusted dynamically.

11. The method of splitting ad revenue with a reporter or an owner of a video content, as recited in claim 1, wherein said percentage is adjusted conditionally.

12. The method of splitting ad revenue with a reporter or an owner of a video content, as recited in claim 1, wherein said unique identification code is based on public-private key infrastructure.

13. The method of splitting ad revenue with a reporter or an owner of a video content, as recited in claim 1, wherein said unique identification code is based on an encryption method.

14. The method of splitting ad revenue with a reporter or an owner of a video content, as recited in claim 1, said method comprises: rating said video.

15. The method of splitting ad revenue with a reporter or an owner of a video content, as recited in claim 1, said method comprises: reporting said video as offensive.

16. The method of splitting ad revenue with a reporter or an owner of a video content, as recited in claim 1, said method comprises: evaluating said video as being offensive.

17. The method of splitting ad revenue with a reporter or an owner of a video content, as recited in claim 1, said method comprises: deleting said video as offensive.

18. The method of splitting ad revenue with a reporter or an owner of a video content, as recited in claim 1, said method comprises: generating total accounting report for said reporter.

19. The method of splitting ad revenue with a reporter or an owner of a video content, as recited in claim 1, said method comprises: crowdsourcing said event to public, for video capturing.

20. The method of splitting ad revenue with a reporter or an owner of a video content, as recited in claim 1, said method comprises: metering said video for accounting purposes and rating purposes.
